(19) United States
(12) Patent Application Publication
(10) Pub. No.: US 2011/0286900 A1
(43) Pub. Date: Nov. 24, 2011

(54) PGM-Zoned Catalyst for Selective Oxidation of Ammonia in Diesel Systems

(75) Inventors: Matthew T. Caudle, Hamilton, NJ (US); Jaya L. Mohanan, Edison, NJ (US); Martin Dieterle, Jersey City, NJ (US)

(73) Assignee: BASF Corporation, Florham Park, NJ (US)

(21) Appl. No.: 12/785,159

(22) Filed: May 21, 2010

(51) Int. Cl. B01D 53/94; B01J 29/00; B01J 23/42

(52) U.S. Cl. 423/213.5; 502/339; 502/74

(57) ABSTRACT

Platinum group metal zoned ammonia oxidation catalytic articles and methods of making are described. Also described are emissions treatment systems and methods of treating an exhaust stream containing ammonia using a platinum group metal zoned ammonia oxidation catalytic article.

### TECHNICAL FIELD

Embodiments of the invention pertain to catalysts, methods for their manufacture, and methods of treating emissions in an exhaust stream. More specifically, embodiments of the invention pertain to catalysts, methods and systems including a zoned ammonia oxidation catalyst.

### BACKGROUND

Diesel engine exhaust is a heterogeneous mixture that contains particulate emissions such as soot and gaseous emissions such as carbon monoxide, unburned or partially burned hydrocarbons, and nitrogen oxides (collectively referred to as NOₓ). Catalyst compositions, often disposed on one or more monolithic substrates, are placed in engine exhaust systems to convert certain or all of these exhaust components to innocuous compounds.

Ammonia selective catalytic reduction (SCR) is a NOₓ abatement technology that will be used to meet strict NOₓ emission targets in diesel and lean-burn engines. In the ammonia SCR process, NOₓ (normally consisting of NO+NO₂) is reacted with ammonia (or an ammonia precursor such as urea) to form dinitrogen (N₂), also referred to as molecular nitrogen, over a catalyst typically composed of base metals. This technology is capable of NOₓ conversions greater than 90% over a typical diesel driving cycle, and thus it represents one of the best approaches for achieving aggressive NOₓ abatement goals.

A characteristic feature of some ammonia SCR catalyst materials is a propensity to retain considerable amounts of ammonia on Lewis and Brønsted acid sites on the catalyst surface during low temperature portions of a typical driving cycle. A subsequent increase in exhaust temperature can cause ammonia to desorb from the ammonia SCR catalyst surface and exit the exhaust pipe of the vehicle. Overdosing ammonia in order to increase NOₓ conversion rate is another potential scenario where ammonia may exit from the ammonia SCR catalyst.

Ammonia slip from the ammonia SCR catalyst presents a number of problems. The odor threshold for NH₃ is 20 ppm in air. Eye and throat irritation are noticeable above 100 ppm, skin irritation occurs above 400 ppm, and the IDLH is 500 ppm in air. Ammonia is caustic, especially in its aqueous form. Condensation of NH₃ and water in cooler regions of the exhaust line downstream of the exhaust catalysts will give a corrosive mixture.

Therefore, it is desirable to eliminate the ammonia before it can pass into the tailpipe. A selective ammonia oxidation (AMOx) catalyst is employed for this purpose, with the objective to convert the excess ammonia to N₂. It would be desirable to provide a catalyst for selective ammonia oxidation that is able to convert ammonia at a wide range of temperatures where ammonia slip occurs in the vehicles driving cycle, and can produce minimal nitrogen oxide byproducts. The AMOx catalyst should also produce minimal N₂O, which is a potent greenhouse gas.

Selective NH₃ oxidation is an enabling technology in heavy duty diesel SCR systems. As Original Equipment Manufacturers push to inject ammonia at temperatures greater than 500° C., including during a filter regeneration event, the performance of the ammonia oxidation catalyst at high temperature becomes increasingly important. Supported platinum converts all ammonia to NO and NO₂ above 400° C., but the desired product is N₂. To increase N₂ selectivity, a topcoat layer consisting of an SCR catalyst material, has been applied over the platinum-containing layer. This strategy allowed for increased N₂ yield at 500° C., and dinitrogen yield can be increased further by increasing the SCR topcoat loading. However, this improvement comes at the expense of increasing NH₃ lightoff temperatures. Dinitrogen selectivity can also be increased by decreasing the platinum loading to below 1.0 g/ft³ in the bottom layer, but this also comes at the expense of decreased NH₃ conversion. Therefore, there is a need for improved AMOx catalyst designs that permit the simultaneous optimization of NH₃ lightoff and N₂ selectivity.

### SUMMARY

A first aspect of the invention pertains to a catalytic article. In one embodiment, a catalytic article comprises a substrate having an inlet end and an outlet end defining an axial length; an undercoat washcoat layer on the substrate comprising an inlet zone and an outlet zone, the inlet zone having an inlet platinum group metal with an inlet platinum group metal loading, the inlet zone extending from the inlet end of the substrate through less than the entire axial length of the substrate, the outlet zone having an outlet platinum group metal with an outlet platinum group metal loading, the outlet zone extending from the outlet end of the substrate through less than the entire axial length of the substrate, wherein the outlet metal loading is greater than the inlet metal loading and there is substantially no overlap between the inlet zone and the outlet zone; and a topcoat washcoat layer over the undercoat layer, the topcoat layer comprising an SCR composition effective for selective catalytic reduction of ammonia.

In specific embodiments, at least one of the inlet platinum group metal and the outlet platinum group metal is platinum and the platinum is supported on refractory metal oxide support. According to one or more embodiments, the inlet zone extends in the range of about 25% to about 75% of the axial length of the substrate, with the remaining axial length taken up by the outlet zone. In specific embodiments, the inlet zone extends in the range of about 45% to about 55% of the axial length of the substrate, with the remaining axial length taken up by the outlet zone.

According to specific embodiments, the inlet platinum group metal loading and outlet platinum group metal loading are present in about a 1:10 ratio. In more specific embodiments, the ratio of the inlet platinum group metal loading to the outlet platinum group metal loading is in the range of about 1:2 to about 1:10. In one or more embodiments, the inlet platinum group metal loading is in the range of about 0.1 g/ft³ to about 2 g/ft³. In specific embodiments, the inlet platinum group metal loading is about 0.5 g/ft³. In other specific embodiments, the outlet platinum group metal loading is in the range of about 1 g/ft³ and about 10 g/ft³. In more specific embodiments, the outlet platinum group metal loading is about 5 g/ft³. In highly specific embodiments, the inlet platinum group metal loading is about 0.5 g/ft³ and the outlet platinum group metal loading is about 5 g/ft³.

According to one or more embodiments, the SCR composition comprises a microporous molecular sieve. In one or more embodiments, the SCR composition comprises vanadium and a refractory metal oxide.

Another aspect of the invention pertains to a method for treating emissions produced in an exhaust gas stream of a diesel engine. According to one embodiment, the method comprises passing the exhaust gas stream through an inlet zone of a catalytic article, the inlet zone comprising a substrate, a top layer with an SCR component and an undercoat with an inlet platinum group metal having an inlet metal loading; passing the exhaust gas stream through an outlet zone of the catalytic article, the outlet zone comprising the substrate and top layer of the inlet zone and an undercoat with an outlet platinum group metal having an outlet metal loading, the outlet metal loading being greater than the inlet metal loading. In one or more embodiments, the inlet platinum group metal and the outlet platinum group metal is platinum. In specific embodiments, the inlet platinum group metal and the outlet platinum group metal are supported on alumina refractory metal oxide support. In one or more embodiments, the substrate is a flow-through honeycomb monolith. In specific embodiments of the method, the SCR component comprises a microporous molecular sieve.

Another aspect of the invention pertains to a method of preparing a catalyst article for the treatment so an exhaust stream containing NOₓ. According to one embodiment, the method comprises coating an outlet end of a substrate along at least about 25% of the substrate length with an outlet undercoat washcoat layer containing an outlet platinum group metal with an outlet loading on an outlet high surface area refractory metal oxide support; coating an inlet end of the substrate with an inlet undercoat washcoat layer containing an inlet platinum group metal with an inlet loading on an inlet high surface area refractory metal oxide support, and the outlet loading is greater than the inlet loading; drying and calcining the coated substrate to fix the undercoat washcoat layers on the substrate; coating the substrate with a topcoat layer comprising a composition effective for selective catalyzing reduction of ammonia, the topcoat layer covering both the inlet undercoat washcoat layer and the outlet undercoat washcoat layer; and drying and calcining the coated substrate to fix the SCR composition onto the inlet undercoat washcoat layer and the outlet undercoat washcoat layer. In specific embodiments of the method, at least one of the inlet platinum group metal and outlet platinum group metal comprises platinum. In one or more embodiments of the method, the ratio of the inlet loading to outlet loading is in the range of about 1:2 to about 1:10. In specific embodiments, the substrate is a flow through honeycomb monolith. In specific embodiments, the SCR composition comprises a microporous molecular sieve. According to one or more embodiments, the SCR composition comprises vanadium and a refractory metal oxide.

### BRIEF DESCRIPTION OF THE DRAWINGS

FIG. 1 shows a cross-sectional representation of a single channel in a coated catalytic article according to one or more embodiments of the invention;

FIG. 2 shows a cross-sectional representation of the washcoat in a coated catalytic article according to one or more embodiments of the invention, showing the relevant chemistry occurring in each washcoat layer;

FIG. 3 shows three process steps for making a catalytic article according to one or more embodiments of the invention;

FIG. 4 shows emission treatment system according to one or more embodiments of the invention;

FIGS. 5A and 5B show graphs of the ammonia conversion and N₂ yield as a function of temperature according to one or more embodiments of the invention; and

FIGS. 6A and 6B show graphs depicting the effect of the length of the platinum-containing undercoat zones on the ammonia conversion and N₂ selectivity in zoned AMOx catalysts.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the singular forms “a”, “an” and “the” include plural referents unless the context clearly indicates otherwise. Thus, for example, reference to “a catalyst” includes a mixture of two or more catalysts, and the like. As used herein, the term “abate” means to decrease in amount and “abatement” means a decrease in the amount, caused by any means. Where they appear herein, the terms “exhaust stream” and “engine exhaust stream” refer to the engine out effluent as well as to the effluent downstream of one or more other catalyst system components including but not limited to a diesel oxidation catalyst and/or soot filter.

An aspect of the invention pertains to a catalyst. According to one or more embodiments, the catalyst may be disposed on a monolithic substrate as a washcoat layer to provide a catalytic article. As used herein and as described in Heck, Ronald and Robert Farrauto, Catalytic Air Pollution Control, New York: Wiley-Interscience, 2002, pp. 18-19, a washcoat layer consists of a compositionally distinct layer of material disposed on the surface of the monolithic substrate or an underlying washcoat layer. A catalyst can contain one or more washcoat layers, and each washcoat layer can have unique chemical catalytic functions.

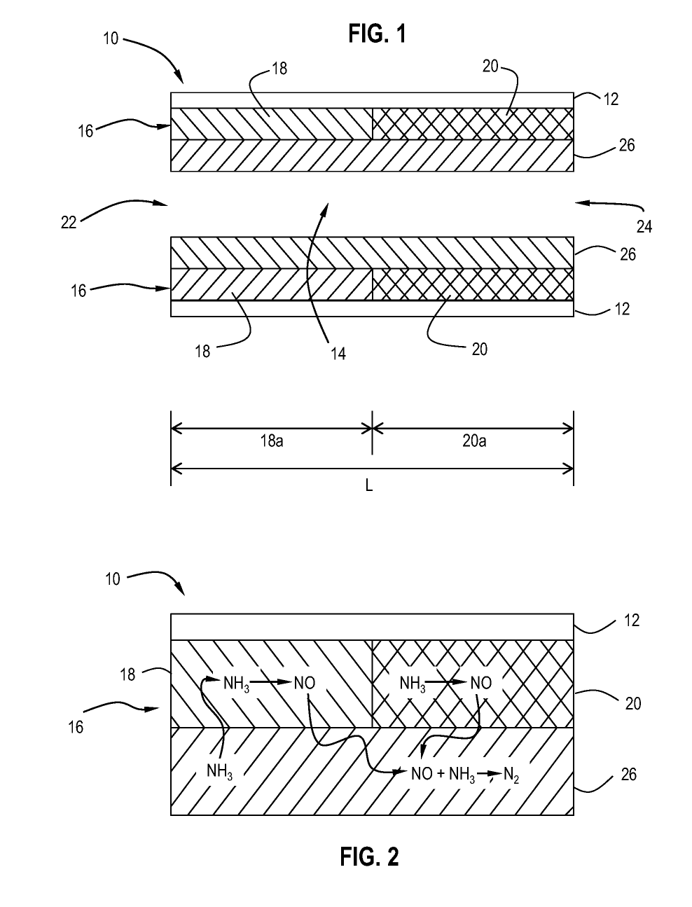

With reference to FIG. 1, one or more embodiments of the invention are directed to catalytic articles 10. The catalytic articles comprise a substrate 12, often referred to as a carrier or carrier substrate. The substrate 12 has an inlet end 22 and an outlet end 24 defining an axial length L. In one or more embodiments, the substrate 12 generally comprises a plurality of channels 14 of a honeycomb substrate, of which only one is shown in cross-section for clarity. An undercoat layer 16 on the substrate comprises two zones; an inlet zone 18 and an outlet zone 20. The inlet zone 18 has an inlet platinum group metal with an inlet metal loading. The inlet zone 18 extends from the inlet end 22 of the substrate 12 through less than the entire axial length L of the substrate 12. The length of the inlet zone 18 is denoted as 18a in FIG. 1. The outlet zone 20 has an outlet platinum group metal with an outlet loading. The outlet zone 20 extends from the outlet end 24 of the substrate 12 through less than the entire axial length L of the substrate 12. The outlet metal loading is greater than the inlet metal loading and there is substantially no overlap between the inlet zone 18 and the outlet zone 20. A topcoat layer 26 is over the undercoat layer 16. The topcoat layer 26 comprises an SCR composition which is effective for the selective catalytic reduction of NOₓ.

Without being bound to any particular theory of operation, FIG. 2 illustrates how the undercoat layer 16 and topcoat layer 26 function together to increase the N₂ selectivity for NH₃ oxidation in the AMOx catalyst of one or more embodiment. Ammonia molecules move down the channel 14 (FIG. 1) while colliding with the washcoat topcoat layer 26 comprising an SCR catalyst. The molecule can diffuse into and out of the topcoat layer 26, but it is not otherwise converted by the catalyst until it contacts the undercoat layer 16, which contains a composition that includes an NH₃ oxidation component. In the undercoat layer 16, the ammonia is initially converted to NO, which subsequently may diffuse to the topcoat layer 26. In the topcoat layer 26 containing an SCR catalyst composition, the NO may react with NH₃ to form N₂, thereby increasing the net selectivity to N₂. At high temperatures (e.g., greater than about 400° C.) most of the NH₃ will be converted in the inlet zone 18 of the catalyst article, where the Pt concentration is lower and the ratio of NOₓ production (by Pt) and NOₓ consumption (by SCR) strongly favors net N₂ formation. At low temperatures (e.g., about 250° C.), NH₃ is converted over the entire catalyst length, and the higher Pt loading in the outlet zone 20 can be used to maintain a low NH₃ lightoff temperature. The ratio of the inlet zone length 18a to outlet zone length 20a, and the ratio of inlet zone Pt loading to outlet zone Pt loading give means to control high-temperature N₂ selectivity and low temperature NH₃ conversion in a more independent way than is possible with a longitudinally uniform catalyst.

As used in this specification and the appended claims, the terms “SCR function”, “selective catalytic reduction function”, and the like, refer to chemical processes described by the stoichiometric Equations 1 and 2.

4NO+4NH₃+O₂→4N₂+6H₂O (1)

4NO₂+4NH₃→4N₂+O₂+6H₂O (2)

More generally, these phrases refer to any chemical process in which NOₓ and NH₃ are combined to preferably produce N₂.

As used in this specification and the appended claims, the terms “SCR component”, “SCR composition”, “selective catalytic reduction composition”, and the like, refer to a material composition effective to catalyze the SCR function over a temperature range up to 500° C. As such, platinum group metals (“PGM”s) such as platinum are not included as SCR components or SCR compositions.

As used in this specification and the appended claims, the terms “NH₃ oxidation function”, “ammonia oxidation function”, and the like, refer to a chemical process described by Equation 3.

4NH₃+5O₂→4NO+6H₂O (3)

More generally, these phrases refer to a process in which NH₃ is reacted with oxygen to produce NO, NO₂, N₂O, or preferably N₂.

As used in this specification and the appended claims, the terms “NH₃ oxidation composition”, “ammonia oxidation composition”, and the like, refer to a material composition effective to catalyze the NH₃ oxidation function.

### The Substrate

According to one or more embodiments, the substrate for the catalyst may be any of those materials typically used for preparing automotive catalysts and will typically comprise a metal or ceramic honeycomb structure. Any suitable substrate may be employed, such as a monolithic flow-through substrate having a plurality of fine, parallel gas flow passages extending from an inlet to an outlet face of the substrate, such that passages are open to fluid flow. The passages, which are essentially straight paths from their fluid inlet to their fluid outlet, are defined by walls on which the catalytic material is coated as a “washcoat” so that the gases flowing through the passages contact the catalytic material. The flow passages of the monolithic substrate are thin-walled channels which can be of any suitable cross-sectional shape such as trapezoidal, rectangular, square, sinusoidal, hexagonal, oval, circular, etc. Such structures may contain from about 60 to about 1200 or more gas inlet openings (i.e., “cells”) per square inch of cross section (cpsi). A representative commercially-available flow-through substrate is the Corning 400/6 cordierite material, which is constructed from cordierite and has 400 cpsi and wall thickness of 6 mil. However, it will be understood that the invention is not limited to a particular substrate type, material, or geometry.

Ceramic substrates may be made of any suitable refractory material, e.g., cordierite, cordierite-α alumina, silicon nitride, zircon mullite, spodumene, alumina-silica magnesia, zircon silicate, sillimanite, magnesium silicates, zircon, petalite, a alumina, aluminosilicates and the like.

The substrates useful for the catalysts according to one or more embodiments of the present invention may also be metallic in nature and be composed of one or more metals or metal alloys. Exemplary metallic supports include the heat resistant metals and metal alloys such as titanium and stainless steel as well as other alloys in which iron is a substantial or major component. Such alloys may contain one or more of nickel, chromium and/or aluminum, and the total amount of these metals may comprise at least 15 wt. % of the alloy, e.g., 10-25 wt. % of chromium, 3-8 wt. % of aluminum and up to 20 wt. % of nickel. The alloys may also contain small or trace amounts of one or more other metals such as manganese, copper, vanadium, titanium and the like. The metallic substrates may be employed in various shapes such as corrugated sheet or monolithic form. A representative commercially-available metal substrate is manufactured by Emitec. However, it will be understood that the invention is not limited to a particular substrate type, material, or geometry. The surface of the metal substrates may be oxidized at high temperatures, e.g., 1000° and higher, to form an oxide layer on the surface of the substrate, improving the corrosion resistance of the alloy. Such high temperature-induced oxidation may also enhance the adherence of the refractory metal oxide support and catalytically-promoting metal components to the substrate.

### NH₃ Oxidation Composition

In accordance with one or more embodiments of the invention, a composition effective to catalyze the NH₃ oxidation function is utilized in a NOₓ abatement catalyst. The ammonia contained in an exhaust gas stream is reacted with oxygen over the NH₃ oxidation component to form N₂ over a catalyst according to Equation 3.

According to one or more embodiments, the NH₃ oxidation component may be a supported platinum group metal component which is effective to remove ammonia from the exhaust gas stream. In one or more embodiments, the platinum group metal component includes ruthenium, rhodium, iridium, palladium, platinum, silver or gold. In specific embodiments, the platinum group metal component includes physical mixtures alloys or intermetallic combinations of ruthenium, rhodium, iridium, palladium, platinum, silver and gold.

In detailed embodiments, the ammonia oxidation catalyst includes a graded or zoned undercoat layer 16. The undercoat layer 16 may have a platinum group metal (PGM), with a lower PGM content in an inlet zone 18, and a higher PGM content in the outlet zone 20. As used herein, “AMOx zone”, “ammonia oxidation zone”, “AMOX composition” or “ammonia oxidation composition” may refer to the composite of the topcoat layer 26 containing an SCR catalyst overlying the undercoat layer 16 or 18 containing a PGM. As used herein, “ammonia oxidation layer” specifically refers to a layer containing PGM for oxidizing ammonia, for example undercoat layer 16. It is contemplated that more than two zones or a continuous gradient can be used for the AMOx layer. In specific embodiments, at least one of the inlet platinum group metal and the outlet platinum group metal comprises platinum.

The AMOx zones extend axially through the substrate, with the length of the inlet zone 18 (also called the front zone) and outlet zone 20 (also called the rear zone) being a tunable variable. In detailed embodiments, the inlet zone 18 extends from the inlet end of the substrate through an axial length in the range of about 5% to about 95% of the total axial length of the substrate. In specific embodiments, the inlet zone 18 extends from the inlet end of the substrate through an axial length in the range of about 10% to about 90%, or about 20% to about 80%, or about 30% to about 70%, or about 40% to about 60% of the total axial length of the substrate. In further specific embodiments, the inlet zone 18 extends from the inlet end of the substrate through an axial length in the range of about 45% to about 55% of the total axial length of the substrate. In some specific embodiments, the inlet zone 18 and outlet zone 20 each occupy about 50% of the axial length of the substrate, with the inlet zone 18 starting at the inlet end of the substrate and the outlet zone 20 starting at the outlet end of the substrate.

The inlet zone 18 and outlet zone 20 can overlap slightly. In specific embodiments, there is substantially no overlap between the inlet zone 18 and the outlet zone 20. As used in this specification and the appended claims, the term “substantially no overlap” means that the zones overlap through less than about 10% of the axial length of the substrate, or more specifically, less than about 5% of the axial length of the substrate.

In detailed embodiments, the platinum group metal component of the inlet zone 18 and the outlet zone 20 are different. In some detailed embodiments, the platinum group metal component of the inlet zone 18 and the outlet zone 20 is the same. According to specific embodiments, the platinum group metal component of both the inlet zone 18 and the outlet zone 20 comprises platinum.

The platinum group metal component loading in the inlet zone 18 and outlet zone 20 can be tuned. The loading of each zone can be in the range of about 0.01 g/ft³ to about 5 g/ft³, as long as the outlet zone 20 metal loading is greater than the inlet zone 18 metal loading. In detailed embodiments, the inlet zone 18 metal loading is in the range of about 0.1 g/ft³ to about 1 g/ft³. In specific embodiments, the inlet zone 18 metal loading is about 0.5 g/ft³. In detailed embodiments, the outlet zone 20 metal loading is in the range of about 1 g/ft³ and about 10 g/ft³. In specific embodiments, the outlet zone 20 metal loading is about 5 g/ft³. In more specific embodiments, the inlet zone 18 metal loading is about 0.5 g/ft³ and the outlet zone 20 metal loading is about 5 g/ft³.

In detailed embodiments, the ratio of the inlet zone 18 PGM loading and outlet zone 20 PGM loading are in about a 1:10 ratio. In specific embodiments, the ratio of the inlet zone 18 PGM loading and the outlet zone 20 PGM loading is in the range of about 2:3 to about 1:15, about 1:2 to about 1:10, about 1:3 to about 1:9, about 1:4 to about 1:8 or about 1:5 to about 1:7. In further specific embodiments, the ratio of the inlet zone 18 PGM loading to the outlet zone 20 PGM loading is about 1:2, 1:5, or 1:10.

According to one or more embodiments, the platinum group metal component is deposited on a high surface area refractory metal oxide support. Examples of suitable high surface area refractory metal oxides include, but are not limited to, alumina, silica, titania, ceria, and zirconia, as well as physical mixtures, chemical combinations and/or atomically-doped combinations thereof. In specific embodiments, the refractory metal oxide may contain a mixed oxide such as silica-alumina, amorphous or crystalline aluminosilicates, alumina-zirconia, alumina-lanthana, alumina-chromia, alumina-baria, alumina-ceria, and the like. In specific embodiments, the refractory metal oxide does not include a zeolite. An exemplary refractory metal oxide comprises high surface area γ-alumina having a specific surface area of about 50 to about 300 m²/g.

As otherwise mentioned herein, the NH₃ oxidation composition or zone may include a microporous molecular sieve, which may have any one of the framework structures listed in the Database of Zeolite Structures published by the International Zeolite Association (IZA). The framework structures include, but are not limited to those of the CHA, FAU, BEA, MFI, and MOR types. In one embodiment, a molecular sieve component may be physically mixed with an oxide-supported platinum component. In an alternative embodiment, platinum may be distributed on the external surface or in the channels, cavities, or cages of the molecular sieve.

### SCR Composition

In one or more embodiments, the invention utilizes an SCR component which consists of a microporous inorganic framework or molecular sieve onto which a metal from one of the groups VB, VIIB, VIIB, VIIIB, IB, or IIB of the periodic table has been deposited onto extra-framework sites on the external surface or within the channels, cavities, or cages of the molecular sieves. Metals may be in one of several forms, including, but not limited to, zerovalent metal atoms or clusters, isolated cations, mononuclear or polynuclear oxycations, or as extended metal oxides. In specific embodiments, the metals include iron, copper, and mixtures or combinations thereof.

In certain embodiments, the SCR component contains in the range of about 0.10% and about 10% by weight of a group VB, VIIB, VIIB, VIIIB, IB, or IIB metal located on extraframework sites on the external surface or within the channels, cavities, or cages of the molecular sieve. In preferred embodiments, the extraframework metal is present in an amount of in the range of about 0.2% and about 5% by weight.

The microporous inorganic framework may consist of a microporous aluminosilicate or zeolite having any one of the framework structures listed in the Database of Zeolite Structures published by the International Zeolite Association (IZA). The framework structures include, but are not limited to those of the CHA, FAU, BEA, MFI, MOR types. Non-limiting examples of zeolites having these structures include chabazite, faujasite, zeolite Y, ultrastable zeolite Y, beta zeolite, mordenite, silicalite, zeolite X, and ZSM-5. Some embodiments utilize aluminosilicate zeolites that have a silica/alumina molar ratio (defined as SiO₂/Al₂O₃ and abbreviated as SAR) from at least about 5, preferably at least about 20, with useful ranges of from about 10 to 200.

In a specific embodiment, the SCR component includes an aluminosilicate molecular sieve having a CHA crystal framework type, an SAR greater than about 15, and copper content exceeding about 0.2 wt %. In a more specific embodiment, the SAR is at least about 10, and copper content from about 0.2 wt % to about 5 wt %. Zeolites having the CHA structure, include, but are not limited to natural chabazite, SSZ-13, LZ-218, Linde D, Linde R, Phi, ZK-14, and ZYT-6. Other suitable zeolites are also described in U.S. Pat. No. 7,601,662, entitled “Copper CHA Zeolite Catalysts,” the entire content of which is incorporated herein by reference.

According to one or more embodiments of the invention, SCR compositions which include microporous molecular sieves are provided. As used herein, the terminology “microporous molecular sieve” refers to corner sharing tetrahedral frameworks where at least a portion of the tetrahedral sites may be occupied by silicon or aluminum, or occupied by an element other than silicon or aluminum. Non-limiting examples of such molecular sieves include aluminophosphates, and metal-aluminophosphates, wherein metal could include silicon, copper, zinc or other suitable metals. Such embodiments may include a microporous molecular sieve having a crystal framework type selected from CHA, FAU, MFI, MOR, and BEA.

Microporous molecular sieve compositions can be utilized in the SCR component according to embodiments of the present invention. Specific non-limiting examples include sillicoaluminophosphates SAPO-34, SAPO-37, SAPO-44. Synthesis of synthetic form of SAPO-34 is described in U.S. Pat. No. 7,264,789, which is hereby incorporated by reference. A method of making yet another synthetic microporous molecular sieve having chabazite structure, SAPO-44, is described in U.S. Pat. No. 6,162,415, which is hereby incorporated by reference.

SCR compositions consisting of vanadium supported on a refractory metal oxide such as alumina, silica, zirconia, titania, ceria and combinations thereof are also well known and widely used commercially in mobile applications. Typical compositions are described in U.S. Pat. Nos. 4,010,238 and 4,085,193, of which the entire contents are incorporated herein by reference. Compositions used commercially, especially in mobile applications, comprise TiO₂ on to which WO₃ and V₂O₅ have been dispersed at concentrations ranging from 5 to 20 wt. % and 0.5 to 6 wt. %, respectively. These catalysts may contain other inorganic materials such as SiO₂ and ZrO₂ acting as binders and promoters.

Washcoat Layers

According to one or more embodiments, the SCR component and the NH₃ oxidation component can be applied in washcoat layers, which are coated upon and adhered to the substrate.

For example, a washcoat layer of a composition containing an NH₃ oxidation component may be formed by preparing a mixture or a solution of a platinum precursor in a suitable solvent, e.g. water. Generally, from the point of view of economics and environmental aspects, aqueous solutions of soluble compounds or complexes of the platinum are preferred. Typically, the platinum precursor is utilized in the form of a compound or complex to achieve dispersion of the platinum precursor on the support. For purposes of the present invention, the term “platinum precursor” means any compound, complex, or the like which, upon calcination or initial phase of use thereof, decomposes or otherwise converts to a catalytically active form. Suitable platinum complexes or compounds include, but are not limited to platinum chlorides (e.g. salts of [PtCl₄]²⁻, [PtCl₆]²⁻), platinum hydroxides (e.g. salts of [Pt(OH)₆]²⁻), platinum ammines (e.g. salts of [Pt(NH₃)₄]²⁺,]Pt(NH₃)₄]⁴⁺), platinum hydrates (e.g. salts of [Pt(OH₂)₄]²⁺), platinum bis(acetylacetonates), and mixed compounds or complexes (e.g. [Pt(NH₃)₂(Cl)₂]). A representative commercially-available platinum source is 99% ammonium hexachloroplatinate from Strem Chemicals, Inc., which may contain traces of other platinum group metals. However, it will be understood that this invention is not restricted to platinum precursors of a particular type, composition, or purity. A mixture or solution of the platinum precursor is added to the support by one of several chemical means. These include impregnation of a solution of the platinum precursor onto the support, which may be followed by a fixation step incorporating acidic component (e.g. acetic acid) or a basic component (e.g. ammonium hydroxide). This wet solid can be chemically reduced or calcined or be used as is. Alternatively, the support may be suspended in a suitable vehicle (e.g. water) and reacted with the platinum precursor in solution. Additional processing steps may include fixation by an acidic component (e.g. acetic acid) or a basic component (e.g. ammonium hydroxide), chemical reduction, or calcination.

In one or more embodiments utilizing washcoat layers of an SCR composition, the layer can contain a microporous molecular sieve on which has been distributed a metal from one of the groups VB, VIIB, VIIB, VIIIB, IB, or IIB of the periodic table. An exemplary metal of this series is copper. Exemplary microporous molecular sieves, include, but are not limited to zeolites having one of the following crystal structures CHA, BEA, FAU, MOR, and MFI. A suitable method for distributing the metal on the zeolite is to first prepare a mixture or a solution of the metal precursor in a suitable solvent, e.g. water. Generally, from the point of view of economics and environmental aspects, aqueous solutions of soluble compounds or complexes of the metal are preferred. For purposes of the present invention, the term “metal precursor” means any compound, complex, or the like which, can be dispersed on the zeolite support to give a catalytically-active metal component. For the exemplary Group IB metal copper, suitable complexes or compounds include, but are not limited to anhydrous and hydrated copper sulfate, copper nitrate, copper acetate, copper acetylacetonate, copper oxide, copper hydroxide, and salts of copper ammines (e.g. [Cu(NH₃)₄]²⁺). A representative commercially-available copper source is 97% copper acetate from Strem Chemicals, Inc., which may contain traces of other metals, particularly iron and nickel. However, it will be understood that this invention is not restricted to metal precursors of a particular type, composition, or purity. The molecular sieve can be added to the solution of the metal component to form a suspension. This suspension can be allowed to react so that the copper component is distributed on the zeolite. This may result in copper being distributed in the pore channels as well as on the outer surface of the molecular sieve. Copper may be distributed as copper (II) ions, copper (I) ions, or as copper oxide. After the copper is distributed on the molecular sieve, the solids can be separated from the liquid phase of the suspension, washed, and dried. The resulting copper-containing molecular sieve may also be calcined to fix the copper.

To apply a washcoat layer according to one or more embodiments of the invention, finely divided particles of a catalyst, consisting of the SCR component, the NH₃ oxidation component, or a mixture thereof, are suspended in an appropriate vehicle, e.g., water, to form a slurry. Other promoters and/or stabilizers and/or surfactants may be added to the slurry as mixtures or solutions in water or a water-miscible vehicle. In one or more embodiments, the slurry is comminuted to result in substantially all of the solids having particle sizes of less than about 10 microns, i.e., in the range of about 0.1-8 microns, in an average diameter. The comminution may be accomplished in a ball mill, continuous Eiger mill, or other similar equipment. In one or more embodiments, the suspension or slurry has a pH of about 2 to less than about 7. The pH of the slurry may be adjusted if necessary by the addition of an adequate amount of an inorganic or an organic acid to the slurry. The solids content of the slurry may be, e.g., about 20-60 wt. %, and more particularly about 35-45 wt. %. The substrate may then be dipped into the slurry, or the slurry otherwise may be coated on the substrate, such that there will be a desired loading of the catalyst layer deposited on the substrate. Thereafter, the coated substrate is dried at about 100° C. and calcined by heating, e.g., at 300-650° C. for about 1 to about 3 hours. Drying and calcination are typically done in air. The coating, drying, and calcination processes may be repeated if necessary to achieve the final desired gravimetric amount of the catalyst washcoat layer on the support. In some cases, the complete removal of the liquid and other volatile components may not occur until the catalyst is placed into use and subjected to the high temperatures encountered during operation.

After calcining, the catalyst washcoat loading can be determined through calculation of the difference in coated and uncoated weights of the substrate. As will be apparent to those skilled in the art, the catalyst loading can be modified by altering the solids content of the coating slurry and slurry viscosity. Alternatively, repeated immersions of the substrate in the coating slurry can be conducted, followed by removal of the excess slurry as described above.

### Method of Preparing a Catalyst

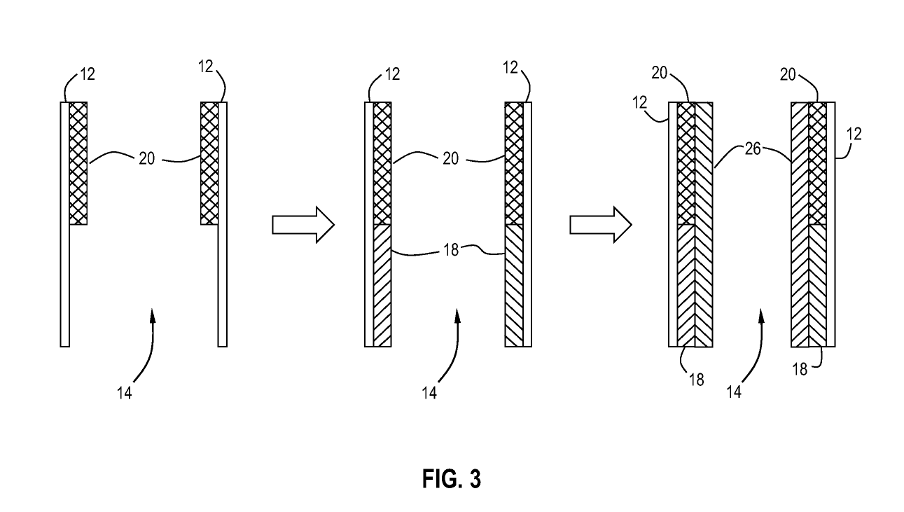

As shown in FIG. 3, a catalyst according to one or more embodiments of the present invention can be prepared in a three-step process. A substrate 12, which, in specific embodiments, contains channels 14 of dimensions in the range of about 100 channels/in² and 1000 channels/in², is coated with an outlet zone undercoat washcoat layer 20, having a composition effective for catalyzing the removal of NH₃. For ease of illustration of the washcoat, only a single channel 14 is shown. In one embodiment, the outlet undercoat washcoat layer 20 is applied to at least about 5% of the substrate length. The outlet undercoat washcoat layer 20 contains an outlet platinum group metal with an outlet loading on an outlet high surface area refractory metal oxide support.

The substrate 12 is coated with an inlet undercoat washcoat layer 18, having a composition effective for catalyzing the removal of NH₃. In one embodiment, the inlet undercoat washcoat layer 18 contains an inlet platinum group metal with an inlet loading on an inlet high surface area refractory metal oxide support. In specific embodiments, the inlet undercoat washcoat layer 18 and outlet undercoat washcoat layer 20 have substantially no overlap. In detailed embodiments, the outlet loading is greater than the inlet loading.

The inlet undercoat washcoat layer 18 and the outlet undercoat washcoat layer 20 are distributed, dried and calcined as described in the preceding section. Generally, it is desirable to at least dry and/or calcine the layer applied to the first zone prior to applying a layer to the second zone. Thus, in specific embodiments, the inlet undercoat washcoat layer 18 and the outlet undercoat washcoat layer 20 are distributed, dried and calcined separately. The order of application of the inlet undercoat washcoat layer 18 and the outlet undercoat washcoat layer 20 can be varied, with either being applied first. In specific embodiments, the outlet undercoat washcoat layer 20 is applied before the inlet undercoat washcoat layer 18.

The substrate is then coated with a topcoat layer 26 comprising a composition effective for selectively catalyzing the reduction of NOₓ. The topcoat layer cover both the inlet undercoat washcoat layer 18 and the outlet undercoat washcoat layer 20. To reach the required loading specified for the SCR component, the topcoat layer 26 may be repeated to form multiple coatings of the SCR composition, to collectively form the overcoat layer 26. The topcoat layer 26 is dried and calcined as described in the preceding section to fix the SCR composition onto the inlet undercoat washcoat layer 18 and the outlet zone undercoat washcoat layer 20.

### Treating Emissions

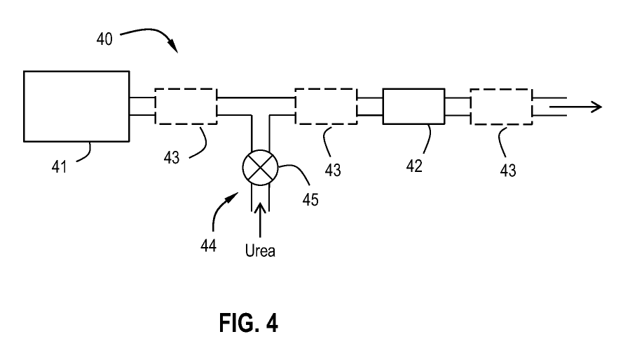

Another aspect of the present invention includes methods for treating emissions produced in the exhaust gas stream of a diesel engine. FIG. 4 shows an emission treatment system 40 of one or more embodiments of the invention. Exhaust gas exiting a diesel engine 41 can include one or more of NOₓ, CO, and hydrocarbons. Diesel engine exhaust is a heterogeneous mixture which contains not only gaseous emissions such as carbon monoxide, unburned hydrocarbons and _{N}Oₓ, but also condensed phase materials (liquids and solids) which constitute the particulates or particulate matter. Often, catalyst compositions and substrates on which the compositions are disposed are provided in diesel engine exhaust systems to convert certain or all of these exhaust components to innocuous components. For example, diesel exhaust systems can contain one or more of a diesel oxidation catalyst and a soot filter, in addition to a catalyst for the reduction of _{N}Oₓ. Embodiments of the present invention can be incorporated into diesel exhaust gas treatment systems known in the art. One such system is disclosed in U.S. Pat. No. 7,229,597, which is incorporated herein by reference in its entirety.

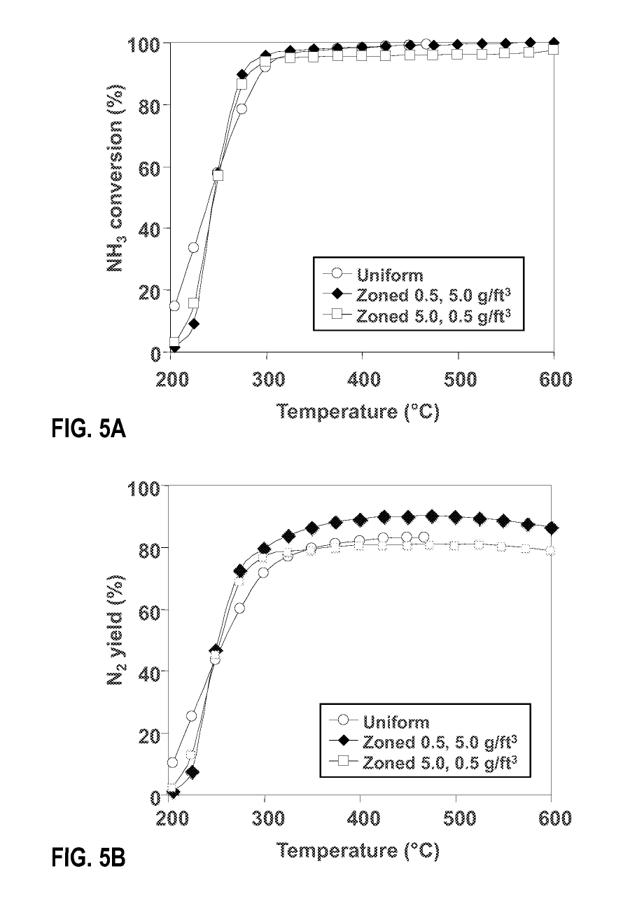

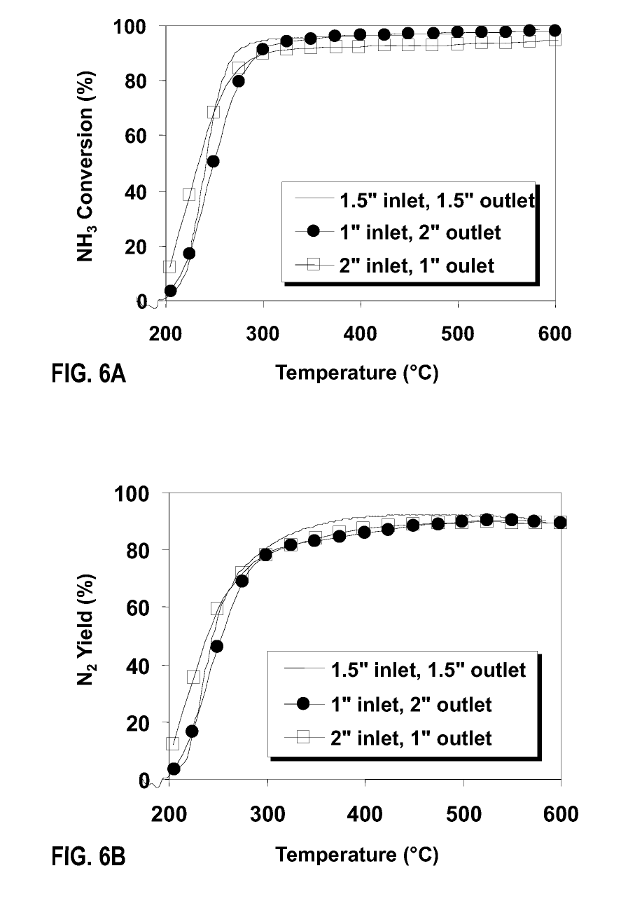

In one or more embodiments, the exhaust gas stream exiting the diesel engine 41 passes through various optional components 43 before and/or after the zoned-AMOx catalytic article 42. The optional components 43 can be one or more of a diesel particulate filter, diesel oxidation catalyst, SCR catalysts, AMOx catalysts, lean NOₓ traps, lean NOₓ storage components and ammonia reduction catalysts. As is understood in the art, it is generally desirable for an AMOx catalyst to be downstream from an SCR catalyst. Other optional components 43 are contemplated and are within the scope of the invention. In specific embodiments, the emissions treatment system 40 includes a urea injector 44 located upstream of and in flow communication with the zoned-AMOx catalytic article 42. The urea injector 44 of detailed embodiments includes a metering device 45 which can be used to adjust the amount of urea entering the exhaust stream. Exhaust gas containing urea then passes through zoned-AMOx catalytic article located downstream of and in flow communication with the urea injector. Aqueous urea can serve as an ammonia precursor which can be mixed with air in a mixing station (not shown). In one or more embodiments, the exhaust gas stream is passed through a zoned-AMOx catalytic article 42. The zoned-AMOx catalytic article 42 includes an inlet zone and an outlet zone. As implied by the name, the inlet zone is upstream of the outlet zone. The inlet zone of the zoned-AMOx catalytic article 42 comprises a substrate, a topcoat with a SCR component and an undercoat with an inlet platinum group metal having an inlet loading. The outlet zone comprises the substrate and top layer of the inlet zone and an undercoat with an outlet platinum group metal having an outlet metal loading. In specific embodiments, the outlet metal loading is greater than the inlet metal loading. FIGS. 5A and 5B show the effect of platinum zoning on the ammonia conversion and N₂ selectivity in zoned AMOx catalysts having Pt/Al₂O₃ undercoats and identical Cu SSZ-13 topcoats. The circles represent a uniform undercoat of 2.0 g/ft³ platinum. The diamonds represent a zoned undercoat having a 1:10 ratio of platinum in the inlet zone to outlet zone (0.5 g/ft³ in the inlet zone and 5.0 g/ft³ in the outlet zone). The squares represent a catalyst having a reverse zoning ratio of 10:1 in the inlet zone and outlet zone. The ammonia conversion data showed an isokinetic point at about 250° C. The undercoat layer zoning changed the shape of the lightoff curve, but had no impact on the T₅₀ for ammonia conversion. The sample with low platinum at the inlet (diamonds) showed superior N₂ yield at all temperatures above 250° C. (FIG. 5B). FIGS. 6A and 6B show the effect of undercoat zoning length variation on the ammonia conversion and N₂ selectivity in zoned AMOx catalysts having 0.5 g/ft³ Pt/Al₂O₃ inlet zone, 5 g/ft³ Pt/Al₂O₃ outlet zone and identical Cu-zeolite topcoats. The solid line represents equal inlet and outlet zone length. The circles represent a zoned undercoat having 1″ inlet zone (0.5 g/ft³ Pt) and 2″ outlet zone (5.0 g/ft³ Pt). The squares represent a catalyst having the reverse zone length scenario, 2″ inlet zone (0.5 g/ft³ Pt) and 1″ outlet zone (5.0 g/ft³ Pt). The ammonia conversion data showed 7° C. decrease in T₅₀ in 2″ inlet, 1″outlet zoning and 7° C. increase in T₅₀ in 1″ inlet 2″ outlet zoning compared to equal zone length of 1.5″ inlet and outlet. This data indicates that inlet and outlet zone length variation has to be much less than 33% for same T₅₀. According to N₂ yield data (FIG. 6B), equal zone length (1.5″) sample and 2″inlet/1″outlet sample have same N₂ yield (70%) at 250° C. However, above 350° C. equal zone length sample and 1″inlet/2″outlet sample show similar N₂ yield (>95%). In other words, undercoat zone length variation has to be kept to a minimum (or equal zone length preferred) to achieve similar NH₃ conversion and N₂ yield.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A catalytic article comprising:
a substrate having an inlet end and an outlet end defining an axial length;
an undercoat washcoat layer on the substrate comprising an inlet zone and an outlet zone, the inlet zone having an inlet platinum group metal with an inlet platinum group metal loading, the inlet zone extending from the inlet end of the substrate through less than the entire axial length of the substrate, the outlet zone having an outlet platinum group metal with an outlet platinum group metal loading, the outlet zone extending from the outlet end of the substrate through less than the entire axial length of the substrate, wherein the outlet metal loading is greater than the inlet metal loading and there is substantially no overlap between the inlet zone and the outlet zone; and
a topcoat washcoat layer over the undercoat layer, the topcoat layer comprising an SCR composition effective for selective catalytic reduction of ammonia.

2. The catalytic article of claim 1, wherein at least one of the inlet platinum group metal and the outlet platinum group metal is platinum.

3. The catalytic article of claim 2, wherein the platinum is supported on refractory metal oxide support.

4. The catalytic article of claim 1, wherein the inlet zone extends in the range of about 25% to about 75% of the axial length of the substrate, with the remaining axial length taken up by the outlet zone.

5. The catalytic article of claim 1, wherein the inlet zone extends in the range of about 45% to about 55% of the axial length of the substrate, with the remaining axial length taken up by the outlet zone.

6. The catalytic article of claim 1, wherein the inlet platinum group metal loading and outlet platinum group metal loading are present in about a 1:10 ratio.

7. The catalytic article of claim 1, wherein the ratio of the inlet platinum group metal loading to the outlet platinum group metal loading is in the range of about 1:2 to about 1:10.

8. The catalytic article of claim 1, wherein the inlet platinum group metal loading is in the range of about 0.1 g/ft³ to about 2 g/ft³.

9. The catalytic article of claim 1, wherein the inlet platinum group metal loading is about 0.5 g/ft³.

10. The catalytic article of claim 1, wherein the outlet platinum group metal loading is in the range of about 1 g/ft³ and about 10 g/ft³.

11. The catalytic article of claim 1, wherein the outlet platinum group metal loading is about 5 g/ft³.

12. The catalytic article of claim 1, wherein the inlet platinum group metal loading is about 0.5 g/ft³ and the outlet platinum group metal loading is about 5 g/ft³.

13. The catalytic article of claim 1, wherein the SCR composition comprises a microporous molecular sieve.

14. The catalytic article of claim 1, wherein the SCR composition comprises vanadium and a refractory metal oxide.

15. A method for treating emissions produced in an exhaust gas stream of a diesel engine, the method comprising:
passing the exhaust gas stream through an inlet zone of a catalytic article, the inlet zone comprising a substrate, a top layer with an SCR component and an undercoat with an inlet platinum group metal having an inlet metal loading;
passing the exhaust gas stream through an outlet zone of the catalytic article, the outlet zone comprising the substrate and top layer of the inlet zone and an undercoat with an outlet platinum group metal having an outlet metal loading, the outlet metal loading being greater than the inlet metal loading.

16. The method of claim 15, wherein the inlet platinum group metal and the outlet platinum group metal is platinum.

17. The method of claim 15, wherein the inlet platinum group metal and the outlet platinum group metal are supported on alumina refractory metal oxide support.

18. The method of claim 15, wherein the substrate is a flow-through honeycomb monolith.

19. The method of claim 15, wherein the SCR component comprises a microporous molecular sieve.

20. A method of preparing a catalyst article for the treatment so an exhaust stream containing NOₓ, the method comprising:
coating an outlet end of a substrate along at least about 25% of the substrate length with an outlet undercoat washcoat layer containing an outlet platinum group metal with an outlet loading on an outlet high surface area refractory metal oxide support;
coating an inlet end of the substrate with an inlet undercoat washcoat layer containing an inlet platinum group metal with an inlet loading on an inlet high surface area refractory metal oxide support, and the outlet loading is greater than the inlet loading;
drying and calcining the coated substrate to fix the undercoat washcoat layers on the substrate;
coating the substrate with a topcoat layer comprising a composition effective for selective catalyzing reduction of ammonia, the topcoat layer covering both the inlet undercoat washcoat layer and the outlet undercoat washcoat layer; and
drying and calcining the coated substrate to fix the SCR composition onto the inlet undercoat washcoat layer and the outlet undercoat washcoat layer.

21. The method of claim 20, wherein at least one of the inlet platinum group metal and outlet platinum group metal comprises platinum.

22. The method of claim 20, wherein the ratio of the inlet loading to outlet loading is in the range of about 1:2 to about 1:10.

23. The method of claim 20, wherein the substrate is a flow through honeycomb monolith.

24. The method of claim 20, wherein the SCR composition comprises a microporous molecular sieve.

25. The catalytic article of claim 20, wherein the SCR composition comprises vanadium and a refractory metal oxide.
